(19) United States
(12) Patent Application Publication
(10) Pub. No.: US 2016/0005056 A1
(43) Pub. Date: Jan. 7, 2016

(54) SYSTEM AND METHOD FOR PREDICTING AFFINITY TOWARDS A PRODUCT BASED ON PERSONALITY ELASTICITY OF THE PRODUCT

(71) Applicant: Wipro Limited, Bangalore (IN)

(72) Inventors: Abhishek Gunjan, Nutan Nagar Gava (IN); Shilpa Gopinath, Trivandrum (IN)

(21) Appl. No.: 14/466,703

(22) Filed: Aug. 22, 2014

(30) Foreign Application Priority Data
Jul. 7, 2014 (IN) 3341/CHE/2014

(51) Int. Cl. G06Q 30/02

(52) U.S. Cl. CPC G06Q 30/0202

(57) ABSTRACT

This technology relates to devices, methods, and non-transitory computer-readable media for predicting affinity of a user towards a product based on personality elasticity of products. The personality elasticity of products means elasticity of affinity towards product with personality profile. The value of elasticity of a product with respect to a personality trait is higher if a difference in personality trait is significant in causing a variation in the affinity towards the product. Further, this technology provides improved product recommendations by correlating personality elasticity of products with big five personality trait model by retrieving user information (like psychographic and demographic details) from different sources. Higher weightage is attributed to more significant personality traits.

This application claims the benefit of Indian Patent Application No. 3341/CHE/2014 filed Jul. 7, 2014, which is hereby incorporated by reference in its entirety.

### FIELD

This technology generally relates to predicting affinity towards a product based on personality elasticity of product, and more particularly to predicting affinity towards the product by correlating personality elasticity of the product with big five personality trait model.

### BACKGROUND

Typically, recommendation systems used are largely based on customer transaction and transaction of similar kind of people. The present system, although consider human behavior and the occasion for which customer is buying product, but do not consider personality traits. The current systems provide least attention to perform recommendation to seller. Thus the seller normally ends up with complex business intelligence product which might not be required all the time.

There is a great need to perform multi-dimensional and multi-level based correlation between two users so that the seller can recommend with great ease which is currently not catered in the existing systems. The seller faces a great deal of problem when it comes to catalyzing less-favorite products which can be done by using the conglomeration of both buyer and supplier with the proposed system

The incapability of existing recommendation is evident from fact that though the margin of product is high still supplier end up making less profit due to existing prediction and recommendation system. The existing system is also based on product popularity and not on whether the customer needs that product or not. Currently, for a supplier, it is easy to sell a product which everyone may like, whereas, it is difficult to sell one which appeals only to a lesser range of personalities. The present day recommender systems fail to cater to supplier's objective of catalyzing out-of-store movement of less-favorite goods. They are user-centric and thereby, incapable of providing a strategy to give an accelerated push for products which are less likely to be recommended.

In view of the above drawbacks, it would be desirable to provide improved recommendations to the seller based on the personality traits of the customer.

### SUMMARY

Disclosed herein is a method for predicting affinity to at least one product based on personality profile of at least one user. The method includes generating at least one personality trait score for each of at least one personality trait for each of the at least one user, the at least one personality trait defined by a personality model; generating at least one elasticity coefficient for each of the at least one personality trait, the elasticity coefficient indicative of variation in the affinity towards the at least one product with respect to the variation in the at least one personality trait; arranging one or more scales based on magnitude of the one or more elasticity coefficients, each of the one or more scales extending between a first scale value and a second scale value; marking, on each of the one or more scales, the personality trait score of the at least one user and corresponding threshold score for users of interest with respect to the at least one product for each of the at least one personality trait to determine difference between the personality trait score and the corresponding threshold score for each of the at least one personality trait; providing one or more weights to the corresponding determined differences based on the magnitude of the elasticity coefficients; and predicting the affinity based on summing the weighted differences between the personality trait score and the corresponding threshold score for each of the at least one personality trait.

In an aspect of this technology, a system for predicting affinity to at least one product based on personality profile of at least one user is disclosed. The system includes one or more hardware processors; and a computer-readable medium storing instructions that, when executed by the one or more hardware processors, cause the one or more hardware processors to perform operations comprising: generating at least one personality trait score for each of at least one personality trait for each of the at least one user, the at least one personality trait defined by a personality model; generating at least one elasticity coefficient for each of the at least one personality trait, the elasticity coefficient indicative of variation in the affinity towards the at least one product with respect to the variation in the at least one personality trait; arranging one or more scales based on magnitude of the one or more elasticity coefficients, each of the one or more scales extending between a first scale value and a second scale value; marking, on each of the one or more scales, the personality trait score of the at least one user and corresponding threshold score for users of interest with respect to the at least one product for each of the at least one personality trait to determine difference between the personality trait score and the corresponding threshold score for each of the at least one personality trait; providing one or more weights to the corresponding determined differences based on the magnitude of the elasticity coefficients; and predicting the affinity based on summing the weighted differences between the personality trait score and the corresponding threshold score for each of the at least one personality trait.

In another aspect of this technology, a non-transitory computer-readable medium storing instructions for predicting affinity to at least one product based on personality profile of at least one user that, when executed by a processor, cause the processor to perform operations comprising: generating at least one personality trait score for each of at least one personality trait for each of the at least one user, the at least one personality trait defined by a personality model; generating at least one elasticity coefficient for each of the at least one personality trait, the elasticity coefficient indicative of variation in the affinity towards the at least one product with respect to the variation in the at least one personality trait; arranging one or more scales based on magnitude of the one or more elasticity coefficients, each of the one or more scales extending between a first scale value and a second scale value; marking, on each of the one or more scales, the personality trait score of the at least one user and corresponding threshold score for users of interest with respect to the at least one product for each of the at least one personality trait to determine difference between the personality trait score and the corresponding threshold score for each of the at least one personality trait; providing one or more weights to the corresponding determined differences based on the magnitude of the elasticity coefficients; and predicting the affinity based on summing the weighted differences between the personality trait score and the corresponding threshold score for each of the at least one personality trait.

Additional objects and advantages of this technology will be set forth in part in the following detailed description, and in part will be obvious from the description, or may be learned by practice of this technology. The objects and advantages of this technology will be realized and attained by means of the elements and combinations particularly pointed out in the appended claims.

### BRIEF DESCRIPTION OF THE DRAWINGS

The accompanying drawings, which constitute a part of this specification, illustrate several embodiments and, together with the description, serve to explain the disclosed principles. In the drawings:

FIG. 1 is a block diagram of a high-level architecture of a portion of an exemplary affinity analytic computing device or system that predicts affinity of a user towards a product based on personality elasticity of product in accordance with some embodiments of this technology;

FIG. 2 illustrates components of data adapter of the exemplary affinity analytic computing device or system in accordance with some embodiment of this technology;

FIG. 3 illustrates components of segmentation engine of the exemplary affinity analytic computing device or system in accordance with some embodiment of this technology;

FIG. 4 illustrates components of segmentation analyzer of the exemplary affinity analytic computing device or system in accordance with some embodiment of this technology;

FIG. 5 illustrates components of personality prediction engine of the exemplary affinity analytic computing device or system in accordance with some embodiment of this technology;

FIG. 6 illustrates components of management information system of the exemplary affinity analytic computing device or system in accordance with some embodiment of this technology;

FIG. 7 illustrates components of affinity prediction engine of the exemplary affinity analytic computing device or system in accordance with some embodiment of this technology;

FIG. 8 illustrates components of feedback engine of the exemplary affinity analytic computing device or system in accordance with some embodiment of this technology;

FIG. 9 is a flowchart of an example of a method for predicting affinity of a user towards a product based on personality elasticity of product in accordance with certain embodiments of this technology that may be executed by the system;

FIG. 10 illustrates an example of a method for retrieving user information in accordance with certain embodiments of this technology;

FIG. 11 illustrates an example of a computation of the personality elasticity of products using big five personality trait model in accordance with some embodiments of this technology;

FIG. 12 illustrates an example of a determination of the product profiling model using elasticity coefficients in accordance with some embodiments of this technology;

FIGS. 13A to 13I illustrates an example of the determination of the product profiler model in accordance with some embodiment of this technology;

FIG. 14 illustrates an example of the determination of the aggregate affinity towards a product by using multidimensional hierarchical correlation between the user-attributes and product profiling model in accordance with some embodiments of this technology; and

FIG. 15 is a block diagram of an example of the affinity analytics computing device that implements this technology as illustrated and described herein.

### DETAILED DESCRIPTION

As used herein, reference to an element by the indefinite article “a” or “an” does not exclude the possibility that more than one of the element is present, unless the contextually requires that there is one and only one of the elements. The indefinite article “a” or “an” thus usually means “at least one.” The disclosure of numerical ranges should be understood as referring to each discrete point within the range, inclusive of endpoints, unless otherwise noted.

As used herein, the terms “comprise,” “comprises,” “comprising,” “includes,” “including,” “has,” “having,” “contains,” or “containing,” or any other variation thereof, are intended to cover a non-exclusive inclusion. For example, a composition, process, method, article, system, device, etc. that comprises a list of elements is not necessarily limited to only those elements but may include other elements not expressly listed. The terms “consist of,” “consists of,” “consisting of,” or any other variation thereof, excludes any element, step, or ingredient, etc., not specified. The term “consist essentially of,” “consists essentially of,” “consisting essentially of,” or any other variation thereof, permits the inclusion of elements, steps, or ingredients, etc., not listed to the extent they do not materially affect the basic and novel characteristic(s) of the claimed subject matter.

This technology relates to an device and a method for improving approaches for providing product recommendations by correlating personality elasticity of products with big five personality trait model by retrieving user information (like psychographic and demographic details) from different sources. This is followed by computing the personality trait score for each of the big five personality traits. Then a product-centered personality profiling is determined using elasticity coefficients. Higher weightage is attributed for the more significant personality traits. Then affinity is predicted based on sum of the weighted differences between the personality trait score of a user with respect to a product and the corresponding representative score of the users buying the same product for each of the big five personality traits.

Affinity to certain products may depend greatly on certain personality traits, whereas affinity towards some others may remain more or less the same. There is a need to draw out coverage of psychographic portfolio of products through a product-centered personality profiling. In this technology area, this technology defines and utilizes a new term defined as personality elasticity of products which represents elasticity of affinity towards product with personality profile. The value of elasticity of a product with respect to a personality trait is higher if a difference in personality trait is significant in causing a variation in the affinity towards that particular product. While evaluating the aggregate affinity of a user towards a product, a higher weightage is attributed to such traits. Thus this technology is able to improve the existing technology area by for example now leveraging this difference in personality elasticity of products to favor less-favorite products.

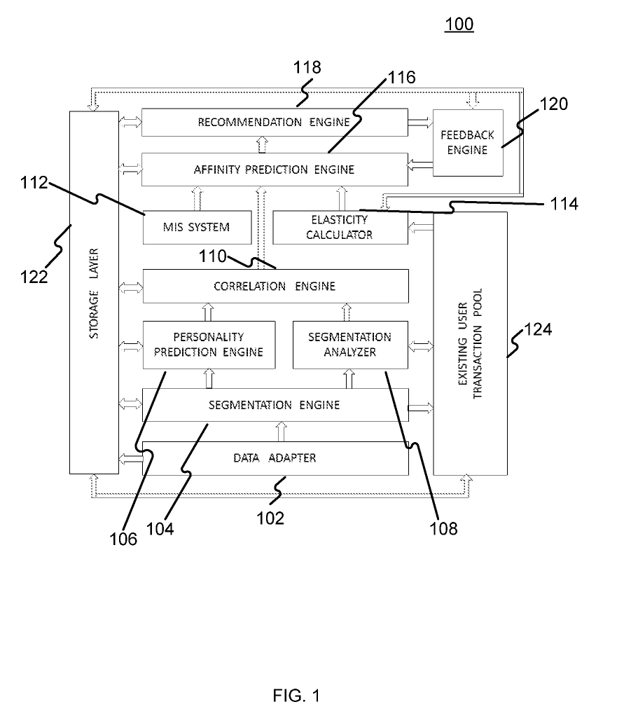

FIG. 1 is a block diagram of a high-level architecture of an example of a portion of an affinity computing device or system 100 that predicts affinity of a user towards a product based on personality elasticity of product in accordance with some embodiments of this technology. In particular, this diagram illustrates examples of the improved functioning provided in the affinity analytics computing device 100 as illustrated and described in greater detail below. By way of example only, the affinity analytics computing device or system 100 may comprise a data adapter 102, a segmentation engine 104, a personality prediction engine 106, a segmentation analyzer 108, a correlation engine 110, a management information system (MIS) 112, an elasticity calculator 114, an affinity prediction engine 116, a recommendation engine 118, a feedback engine 120, a storage layer 122, and an existing user transaction pool 124 which improve the functioning of the affinity analytics computing device or system 100 in predicting affinity towards a product, which may be a good or service.

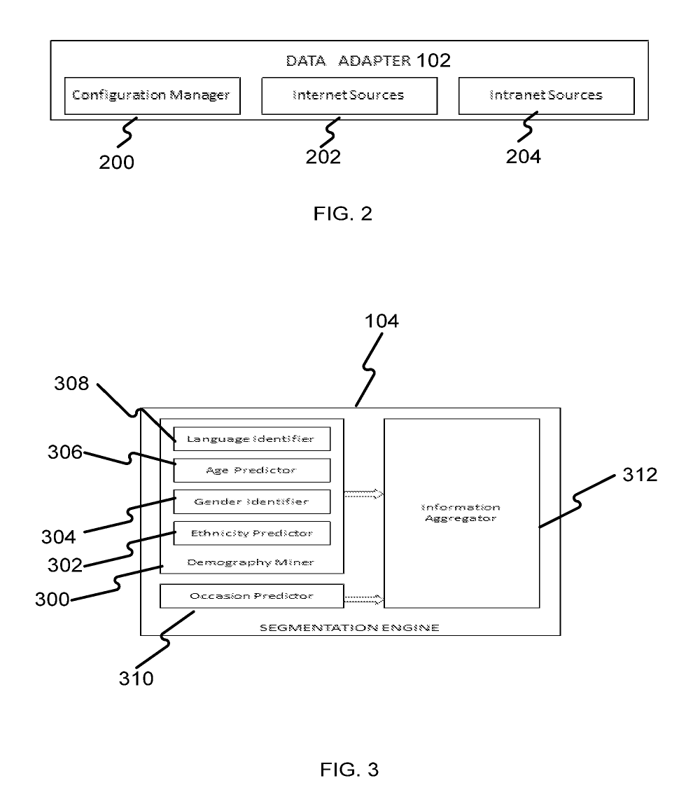

Referring to FIG. 2, the data adapter 102 may comprise a configuration manager 200, internet sources 202, and intranet sources 204. The data adapter 102 may improve functioning of the affinity analytics computing device or system 100 by collecting data from the internet sources 202 and the intranet sources 204 and transferring the collected data to both the storage layer 122 and the segmentation engine 104. The segmentation engine 104 may improve functioning of the affinity analytics computing device or system 100 by implementing a rule based segmentation on data retrieved from the storage layer 122 as per configuration settings set in the data adapter 102.

Referring to FIG. 3, the segmentation engine 104 may further improve functioning of the affinity analytics computing device by including a demography miner 300 that further may comprise a language identifier 302, an age predictor 304, a gender identifier 306, an ethnicity identifier 308. Also, the segmentation engine 104 may further improve functioning of the affinity analytics computing device by further including an occasion predictor 310. The demography miner 300 and the occasion predictor 310 may be communicatively coupled to an information aggregator 312 to further improve functioning of the affinity analytics computing device in making affinity predictions. The information aggregator 312 may further improve functioning of the affinity analytics computing device by uniquely combining information received from the demography miner 300 and the occasion predictor 310 and may store the aggregated information in the form of multidimensional cubes where entities, like occasion, age, gender, relationship etc. become the dimensions.

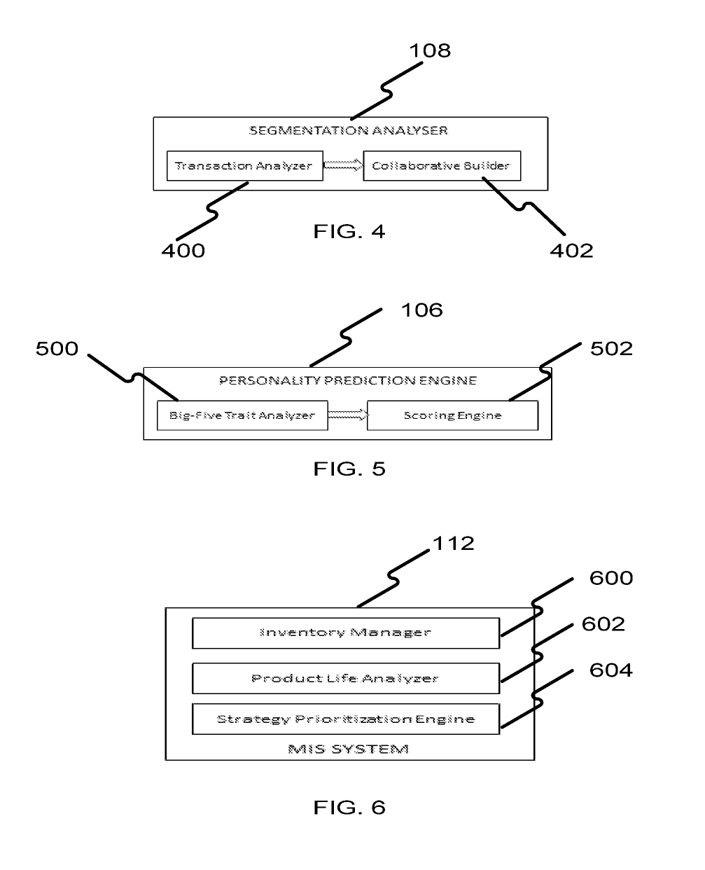

Once the rule base segmentation has been performed by the segmentation engine 104, the segmentation analyzer 108 may improve functioning of the affinity analytics computing device by assimilating information from the existing transaction data pool 124 and multi-dimensional cubes conceived by the segmentation engine 104. Referring to FIG. 4, the segmentation analyzer 108 further may comprise a transaction analyzer 400 and a collaborative builder 402 that improve functioning of the affinity analytics computing device. Further, the personality prediction engine 106 may implement uniquely allocate scores to an existing user base based on the big five personality trait model by way of example only. Referring to FIG. 5, the personality prediction engine 106 further may comprise a big-five trait analyzer 500 and a scoring engine 502 to further improve functioning of the affinity analytics computing device in this technology area. The correlation engine 110 may comprise of a personality based segment analyzer to improve the functioning of the affinity analytics computing device. At a unit cube formed by intersection of all dimensions of the multi-dimensional cube created by the segmentation analyzer 108, lies the set of people belonging to specific age group, gender, ethnicity and language in the event of a particular occasion and the products purchased by them. The user similarity may be uniquely computed by using the personality scores assigned by the personality prediction engine 106. Product similarity may be uniquely computed based on the attributes or features of product available from the storage layer 122. The correlation engine 110 may improve the functioning of the affinity analytics computing device by generating tentative recommendations by technique of collaborative filtering using both user-based and item-based similarity.

The MIS 112 may serve its general function of maintenance of the entire management information system. The information in this module may be analyzed, attuned to the settings in the configurations manager. Referring to FIG. 6, the MIS 112 further may comprise an inventory manager 600, a product life analyzer 602, and a strategy prioritization engine 604.

The elasticity calculator 114 may further improve the functioning of the affinity analytics computing device by calculating an absolute value to represent difference or variation in the affinity towards a product with respect to variation in a personality trait. A similar computation for each trait by the affinity analytics computing device may give a set of five such elasticity coefficients, which are further normalized with respect to the entire product data base, to obtain the Big-Five Elasticity Coefficients.

The affinity prediction engine 116 may further improve the functioning of the affinity analytics computing device by evaluating the suitability of the tentative candidates for recommendation identified by the correlation engine 110, by integrating information provided by the MIS module, product profiles outlined by the elasticity calculator 114 and the feedback engine 120. This module may impart capability of tuning the recommender system to the strategic objectives on the supplier, psychographic portfolio of products and user feedback, over the conventional user-centric approach.

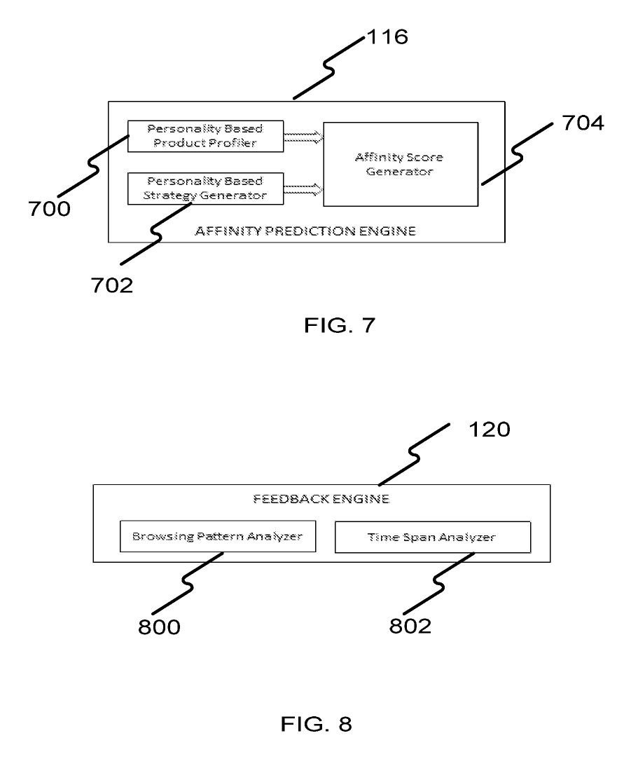

Referring to FIG. 7, the affinity prediction engine 116 further may improve the functioning of the affinity analytics computing device by including a personality based product profiler 700, a personality based strategy generator 702, and an affinity score generator 704.

The feedback engine 120 may improve the functioning of the affinity analytics computing device track by collecting user response and provides it as guidance to the affinity prediction engine 116. Referring to FIG. 8, the feedback engine 120 may further improve the functioning of the affinity analytics computing device track by including a browsing pattern analyzer 800 and a time span analyzer 802.

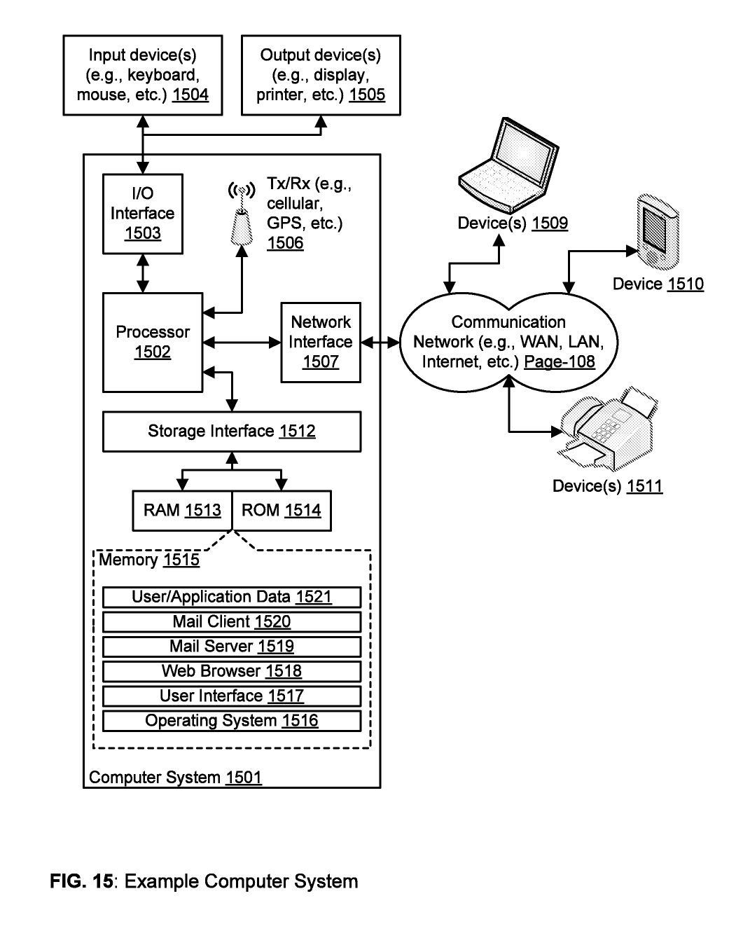

The architecture shown in FIG. 1 may be implemented using one or more hardware processors (not shown in FIG. 1), and a non-transitory computer-readable medium storing instructions (not shown in FIG. 1) configuring the one or more hardware processors, such as the affinity analytics computing device 100 shown in FIG. 1 or affinity analytics computing device 1501 shown in FIG. 15 by way of example only; the one or more hardware processors and the computer-readable medium may also form part of the device or system 100.

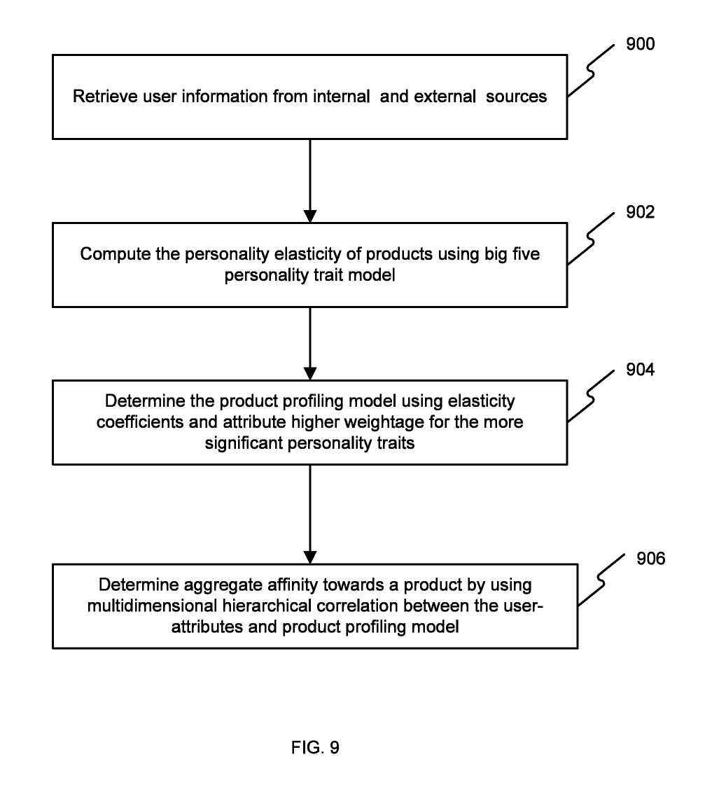

FIG. 9 is a flowchart of an exemplary method for predicting affinity of a user towards a product based on personality elasticity of product in accordance with certain embodiments of this technology that may be executed by the system 100 as described in further detail below. It is noted however, the functions and/or steps of FIG. 9 as implemented by system 100 may be provided by different architectures and/or implementations without departing from the scope of this technology. This example of the method for predicting affinity of a user towards a product also illustrates further examples of the improvements in the functioning of the affinity analytics computing device 100 and also in the underlying affinity analytic technology area.

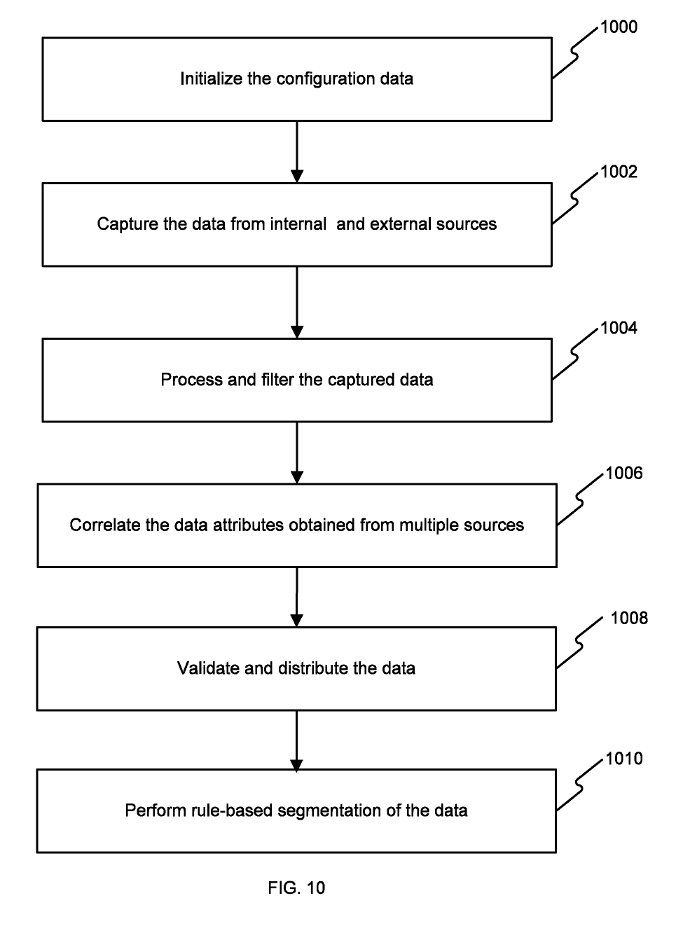

Referring to FIG. 9, at step 900, retrieve user information from internal and external sources. In this information retrieval step, data may be read from multiple sources, using multiple adapters and listeners it contains. The configuration manager 200 may then help in tuning the recommendation system according to the requirements. Retrieval of the user information has been illustrated by way of flowchart in FIG. 10. FIG. 10 illustrates an exemplary method of retrieval of the user information in accordance with certain embodiments of this technology.

Referring to FIG. 10, at step 1000, the configuration data may be initialized. The configuration manager 200 in the data adapter 200 may contain configurable settings with regard to attributes of internal and external data types, significance endowed upon parameters, customization of analysis in accordance with changing business strategies, time span of interest for particular analyses and timely scheduling. Framework may come pre-loaded with data listeners to listen data from multiple sources both internal and external (intranet and internet). It may provide configurable time periods required for specific analysis components, like, number of days of information to be mined for occasion analysis and number of months of data to be processed for personality prediction etc. It also may contain configurable inputs dedicated to changing business goals, decisions, strategies and vision, which direct how the information in the MIS module needs to be characterized and analyzed.

At step 1002, the data may be captured from internal and external types. As per the configurations set in the configuration manager 200, data may be captured from both internal and external sources of data, including that which is internally available, purchased private data and/or publicly available data adapters listens to data from multiple databases, both sql based and no-sql based. Internet-based platforms, crawlers and API service are used for extracting data.

At step 1004, the captured data may be preprocessed and filtered. The data may be filtered based on the requirements specified in the configuration manager 200. Then the data sufficient to mine the parameters and pertaining to the required time period of analysis may be filtered and stored.

At step 1006, data attributes obtained from multiple sources may be correlated. When the information required for rule based segmentation is explicitly provided, the data correlation between relevant attributes obtained from multiple sources of data may be used as confirmatory check to match between the corresponding profiles of users spread across sources. Also, the explicitly available data may be used for the improvement of prediction model accuracy.

At step 1008, the data may be validated and the distributed. Data validation check may be done to determine whether sufficient data for subsequent analysis is available. After listening to relevant information, it first calculates data distribution analysis to find out whether the provided information is sufficient enough to perform analysis or not. The module may tell the user of what all information is incomplete. It then may give a distribution analysis of quality of data present in the existing system and point out what all information is currently missing and how the existing framework can be enhanced. The validated data may be channeled to a distributed storage layer 122.

At step 1010, rule based segmentation of the data may be performed. The segmentation engine 104 may implement rule-based segmentation on data retrieved from the storage layer 122 as per the configurations settings set in the data adapter 104. When the information required is explicitly available, the segmentation engine 104 may use it for confirmatory check on relevant attributes available from all sources. This may affirm integrity of the correlation of multiple data sources. When the information required is to be derived, it is extracted from data using the capabilities of text analytics, image processing, video analytics etc.

The information aggregator 312 in the segmentation engine 104 may combine the information/prediction done by both the demographic miner 300 and occasion predictor 310. For simplicity and ease of use, it may stores aggregated information in the form of multi-dimensional cubes where entities like occasion, age, gender, relationship, etc. becomes the dimensions. Each cube may contain segment of information about people who fall at the intersection of n dimensions. The dynamic hierarchy may be based on the settings in the configuration manager 200. User can also get into either granularity of information or to higher degree of abstraction of information by using features of drill-up or drill-down.

The segmentation analyzer 108 then assimilates information existing in existing user transaction pool 124 and data cubes conceived by the segmentation engine 104. The past occurrences of transactions which have been stored in the existing user transaction pool 124 may be analyzed by the transaction analyzer 400 for each set of dimensions based on the data models created by the segmentation engine 104. For transactions carried out by people belonging to specific age group, gender, ethnicity and language in the event of particular events/occasions, all the products may be associated with the corresponding segment of the data cube.

The transaction analyzer 400 may traverse the entire data cube to find out associated products for each segment or unit cube of the data cubes created by the segmentation engine 104. The collaborative builder 400 eventually may build up a multidimensional hierarchical collaborative matrix as directed by the configuration manager 200.

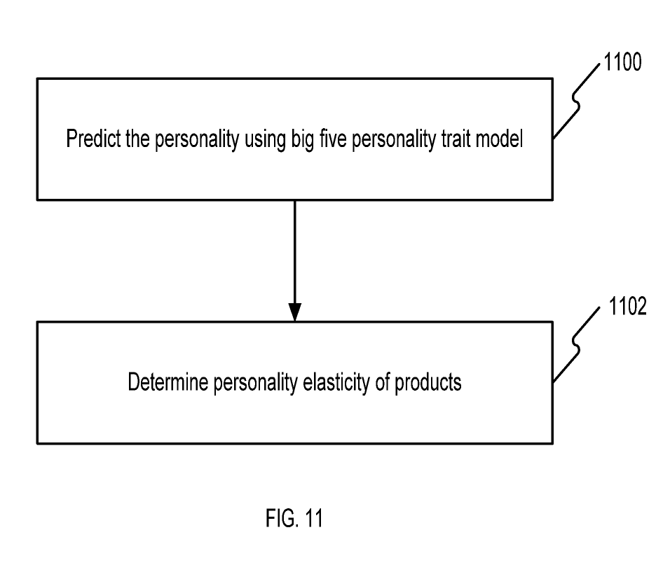

At step 902, the personality elasticity of products may be computed using big five personality trait model. This step may comprise of determination of the Big-Five elasticity coefficients for products by the elasticity calculator 114 by correlating with the personality scores predicted by the personality prediction engine 106. Computation of the personality elasticity of products may be performed using big five personality trait model is illustrated by way of a flowchart in FIG. 11. FIG. 11 illustrates computation of the personality elasticity of products using big five personality trait model in accordance with some embodiments of this technology.

At step 1100, predict the personality using big five personality trait model.

For each person in the existing user base, the textual data pertaining to each user is provided to the Big-Five Trait Analyzer 500 by the segmentation engine 104. The textual data may be analyzed to obtain user's inclination against each personality trait. The personality traits may be as outlined by the big five personality trait model comprising of the big five Factors along with their cluster of specific primary or correlated factors. Textual data may be processed based on taxonomy-based and rule-based classification for categorization corresponding to each trait.

Based on the classification provided by the big-five trait analyzer 500, the scoring engine 502 may compute a score for each personality trait. A configurable, predefined weightage may be assigned to the multiple objective and subjective factors which can be meaningful to assess a personality trait. During the process of computation of an aggregate score, normalization may be done based on the variation of user's scores for all traits. A second level of normalization may be undertaken based on scores of all users in the database. Finally, all the scores may be represented on one or more scales, which may provide a platform for comparison.

At step 1102, determine personality elasticity of products. Affinity to certain products may depend greatly on certain personality traits, whereas affinity towards some others may remain more or less the same. Personality based coefficient calculator may draws out the coverage of psychographic portfolio of products through a product-centered personality profiling. A new term is defined, personality elasticity of products, to represent elasticity of affinity towards product with respect to personality profile. Big five personality trait model provides a base towards the structuring of product profile. According to this model, five broad domains or dimensions of personality that are used to describe human personality may be openness, conscientiousness, extraversion, agreeableness, and neuroticism. For a particular product, from the existing database information, analysis of variation in each of the personality trait of customers, with respect to their affinity towards it, is undertaken as detailed below.

The count of persons, who are positive towards a product, may be plotted against their corresponding score in the scale of each personality trait. A higher count of persons is an indication of affinity towards the product. The value of elasticity of a product with respect to a personality trait is higher if a difference in personality trait is significant in causing a variation in the affinity towards that particular product. Using the technique of regression analysis, an absolute value may be calculated to represent the difference or variation in the affinity towards product with respect to variation in a personality trait. A similar computation for each trait gives a set of five such elasticity coefficients, which are further normalized with respect to the entire product data base, to obtain the Big-Five Elasticity Coefficients.

At step 904, determine the product profiling model using elasticity coefficients and attribute higher weightage for the more significant personality traits. This method may comprise of correlation mining carried out by the correlation engine 110 from the multidimensional hierarchical data cube created by the segmentation analyzer 108. A product profiling model may be formulated by the affinity prediction engine 116, using the Big-Five Elasticity Coefficients computed by the elasticity calculator 114, to draw out the coverage of psychographic portfolio of each product. The advantage of the product centered personality profiling model is that it helps to attribute more weightage to smaller variations in trait of a user from the general benchmark, if the trait is significant (with higher elasticity coefficient).

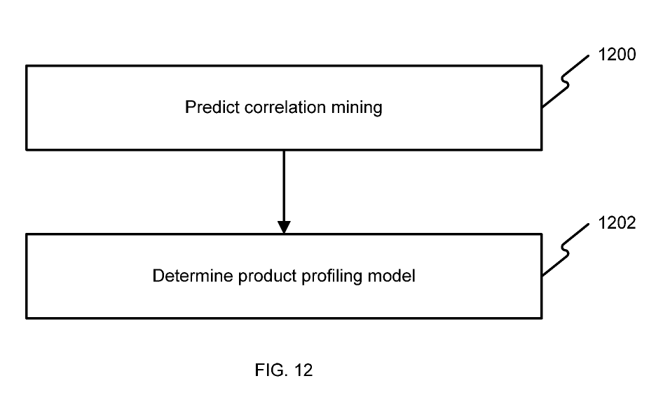

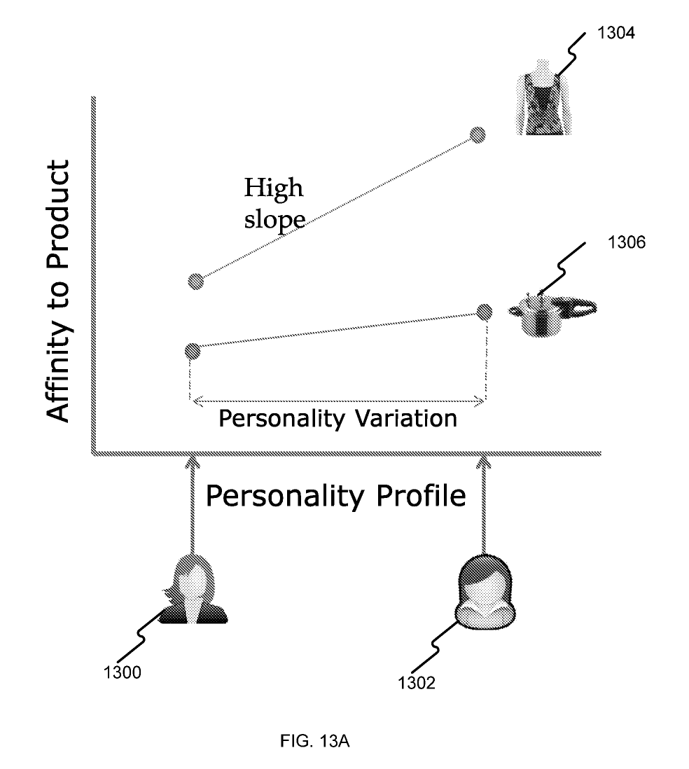

The determination of the product profiling model using elasticity coefficients is illustrated by way of flowchart in FIG. 12. FIG. 12 illustrates determination of the product profiling model using elasticity coefficients in accordance with some embodiments of this technology.

At step 1200, in a unit cube formed by the intersection of all dimensions of the data cube created by the segmentation analyzer 108, lies the set of people belonging to specific age group, gender, ethnicity and language in the event of particular events/occasions and the products purchased by them. The user similarity may be computed by using the personality scores assigned by the personality prediction engine 106. Product similarity may be computed based on the attributes or features of product available from the storage layer 122. The correlation engine 106 may generate tentative recommendations by the technique of collaborative filtering using both user-based and item-based similarity. The correlation engine 106 comprises of a personality based segment analyzer 108. Similarly, correlation scores are generated for each segment or unit cube of the multidimensional hierarchical collaborative matrix created by the segmentation analyzer 108.

At step 1202, the big-five elasticity coefficients computed by the elasticity calculator 114 contribute to the suitability of the product on the basis of the user's personality traits and uniformity or skewness in the significant values of personality traits favoring the product. The affinity prediction engine 116 is capable of leveraging this difference in personality elasticity of products to favor less-favorite products.

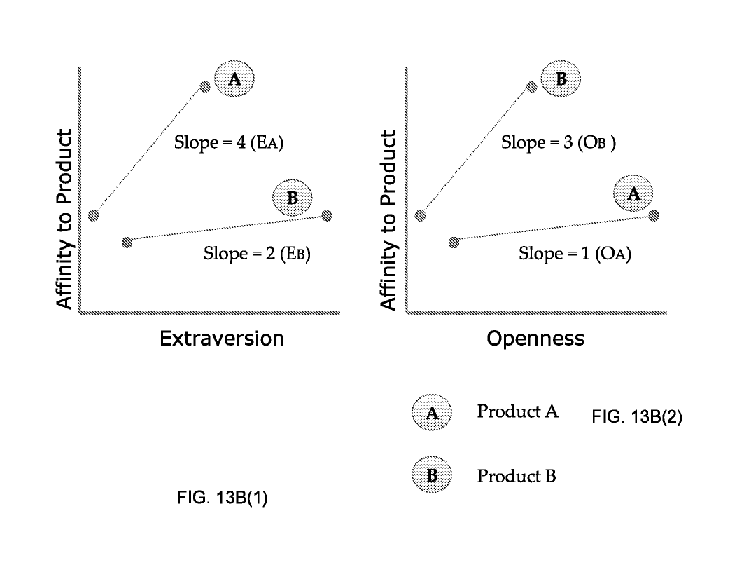

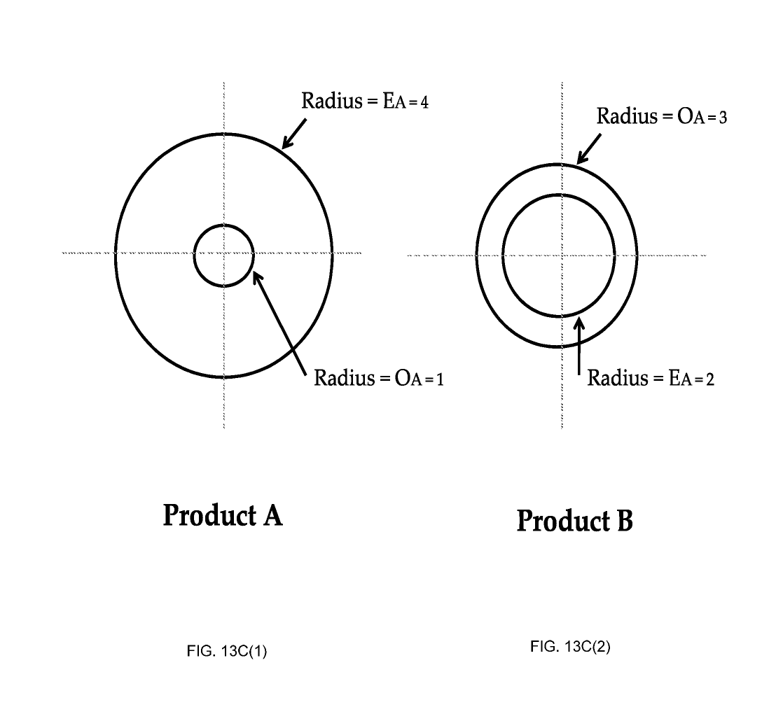

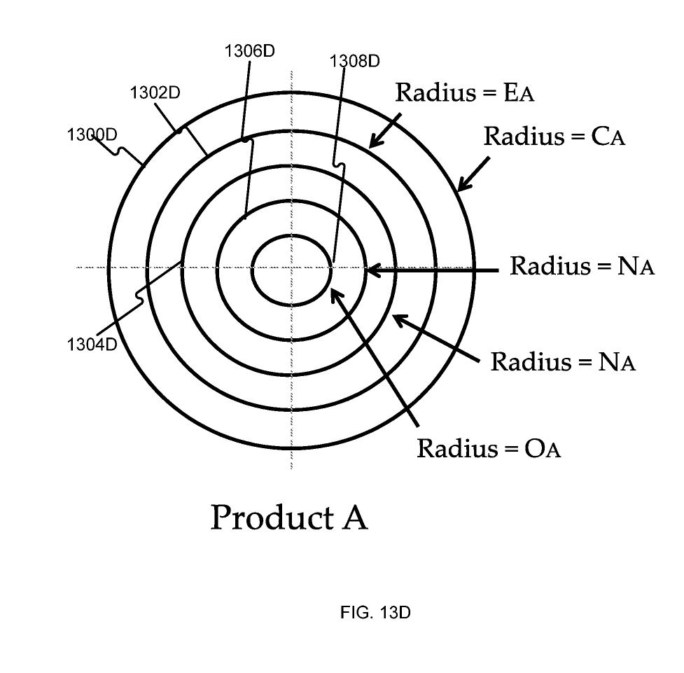

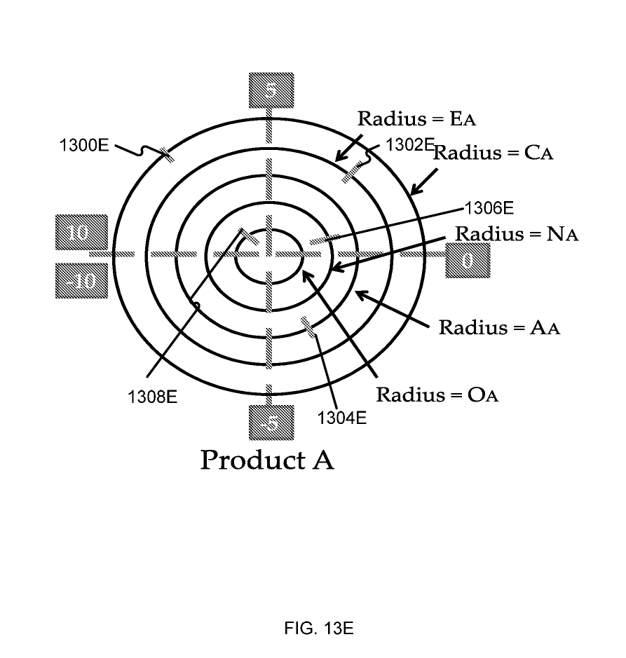

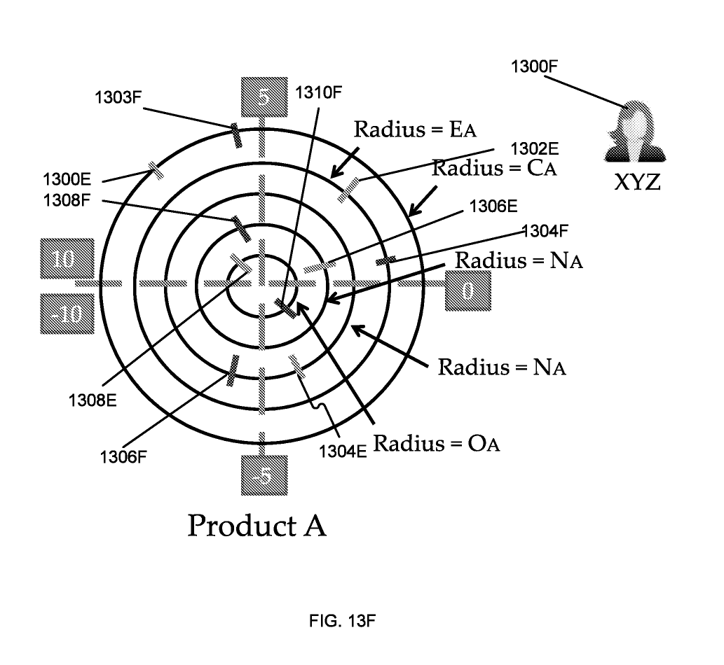

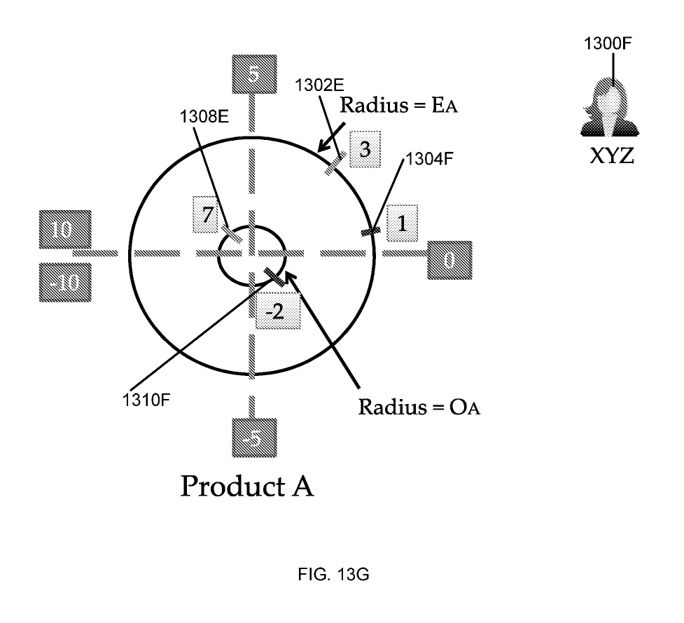

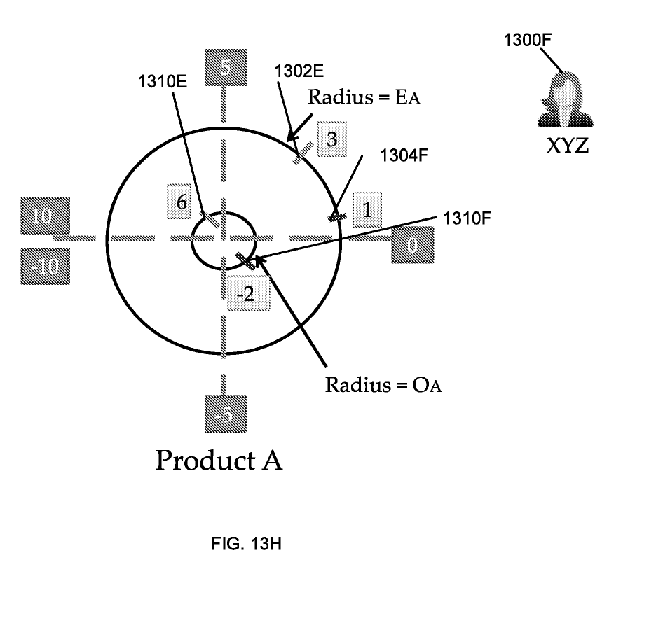

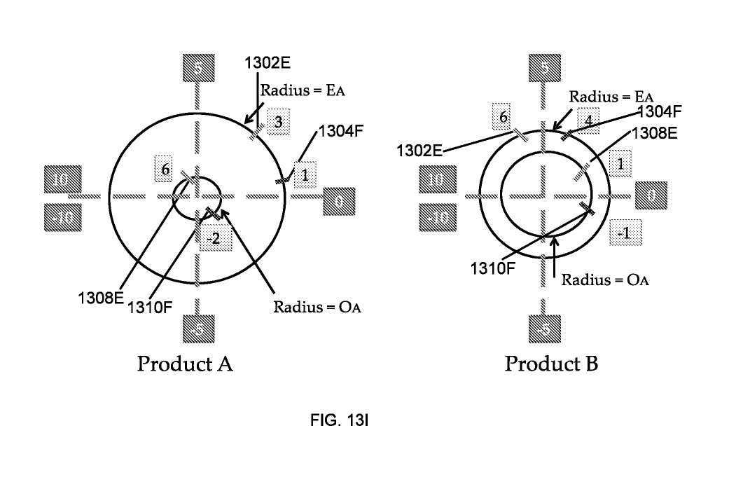

In an exemplary embodiment of this technology shown in FIGS. 13A to 13I, the determination of the product profiler model has been illustrated. In FIG. 13A, the concept of personality elasticity of products has been illustrated. Accordingly, affinity of user 1300 and user 1302 to the products (woman's dress 1304 and the pressure cooker 1306) has been shown. As clearly shown, there is variation in the personality profile of the user 1300 and user 1302. However, for the same difference in the personality profile, affinity towards pressure cooker 1306 is less than the affinity towards woman's dress 1304. Affinity towards the pressure cooker 1306 is more or less the same. However, there is a large variation in the affinity of the user 1300 and the user 1302 towards the woman's dress 1304 with the variation in the personality profile. Variation in affinity towards a product is shown by the slope of the line in the graph between the affinity to product and the personality profile. High variation/elasticity is shown by a high slope and low variation/elasticity is shown by a low slope. Therefore, the personality elasticity of the woman's dress 1304 is more than the personality elasticity of the pressure cooker 1306.

In FIG. 13B, the concept of the trait elasticity of the products has been illustrated in accordance with some embodiments of this technology. According to the big five personality traits model, there are five major personality traits which are used to describe human personality. These five major personality traits are openness, conscientiousness, extraversion, agreeableness, and neuroticism. As shown in FIG. 13B, there are two graphs for the personality traits one for extraversion and the other one for openness. In each of the graphs, affinity to product is a function of the personality trait for two products A and B. In FIG. 13B (1), personality trait “extraversion” has been considered. Affinity of a user to the product A is more than the affinity of the user to the product B as the slope for the product A (4(Ea)) is more than the slope for the product B (2(Eb)) for the personality trait “extraversion”. Similarly, In FIG. 13B(2), personality trait “openness” has been considered. Affinity of a user to the product B is more than the affinity of the user to the product A as the slope for the product A (1(Oa)) is less than the slope for the product B (3(Ob)) for the personality trait “openness”.

In FIG. 13C, concept of personality elasticity of product has been illustrated. Slope for the product is also called as the elasticity coefficient. An elasticity coefficient has been shown to be radii of a circular ring. Higher the elasticity coefficient, higher the radius. Higher elasticity coefficient for a personality trait signifies the importance of the trait. In the FIG. 13C(1), Ea is more than Oa. Therefore, extraversion is more important than openness in determining affinity of the user towards product A. It is to be noted that only for the purpose of the illustration, the circular ring has been shown and elasticity coefficients have been shown to be radii of the circular ring. In another exemplary embodiment, it can be ovular in shape. In yet another implementation, there can be straight lines corresponding to the elasticity coefficients. In another implementation, it can be parabolic in shape. In the FIG. 13C(2), Ea is less than Oa. Therefore, extraversion is less important than openness in determining affinity of the user towards product B.

In FIG. 13D, five concentric circular rings have been shown (1300D, 1302D, 1304D, 1306D, 1308E. Each of the concentric circular rings corresponds to one of the five big five personality traits. Larger the slope (i.e., larger the variation in ‘probability to buy’ with personality trait variation, larger is the significance of that trait), larger the radius. The more significant traits lie on outer rings. The conscientiousness ring 1300D forms the outermost ring and the openness ring 1308E forms the innermost ring 1308E. Therefore extraversion is more important personality trait than the openness as far as the product A is concerned. Similar implementation applies to the product B.

In FIG. 13E, for each of the five concentric rings, a circular scale ranging from −10 to 10 is added onto the five circular concentric rings and passing through 0. Representative scores of persons buying product A in each of the five traits are indicated on the corresponding circular ring. For example, score 1300E represents representative score for the personality trait conscientiousness. Score 1302E represents representative score for the personality trait extraversion. Score 1304E represents representative score for the personality trait agreeableness. Score 1306E represents representative score for the personality trait neuroticism. Score 1308E represents representative score for the personality trait openness.

In FIG. 13F, the personality trait scores of a user 1300F are shown. The personality trait scores (1302F, 1304F, 1306F, 1308F, 1310F) corresponding to (conscientiousness, extraversion, agreeableness, neuroticism, openness). The personality trait scores (1302F, 1304F, 1306F, 1308F, 1310F) are marked on the five concentric circular rings. The affinity of the user 1300F to product A is inversely proportional to the sum of the lengths of arc between the representative personality scores and the personality trait score (1300E and 1302F, 1302E and 1304F, 1304E and 1306F, 1306E and 1308F,) of the user for the five concentric circular rings.

In an exemplary embodiment shown in FIG. 13G, only the circular rings corresponding to the personality trait extraversion and the openness have been considered. For the personality trait openness, suppose the representative personality score 1308E is 2 and the personality trait score 1310F is −1. Similarly, for the personality trait extraversion, suppose the representative score 1304E is 3 and the personality trait score 1302F is 1. For the personality trait openness, the difference between the representative personality score 1308E (1) and the personality trait score 1310F (−2) is 3. Similarly for the personality trait extraversion, the difference is 3−1=2. It can be clearly seen that the length of arc is more for outer circles than for inner circles, for the same variation in circular scale. Therefore, smaller variations in trait of a person from the general benchmark (representative score) is given more weightage, if the trait is significant.

In another exemplary embodiment shown in FIG. 13H, only the circular rings corresponding to the personality trait extraversion and the openness have been considered. For the personality trait extraversion, suppose the representative personality score 1302E is 3 and the personality trait score 1304F is 1. Similarly, for the personality trait openness, suppose the representative score 1308E is 6 and the personality trait score 1310F is −2. Affinity of the user 1300 towards product A or how far is the user 1300 from buying product A is =sum of the length of the arc for the personality trait openness and length of the arc for the personality trait extraversion=2πOa×[(6−(−2))/20]+[(2πEa)×(3−1)/20]=8π+8π for Oa=1 and Ea=4.

In another exemplary embodiment shown in FIG. 13I, only the circular rings corresponding to the personality trait extraversion and the openness have been considered. For the personality trait extraversion, suppose the representative personality score 1302E is 6 and the personality trait score 1304F is 4. Similarly, for the personality trait openness, suppose the representative score 1308E is 1 and the personality trait score 1310F is −1. Affinity of the user 1300 towards product B or how far is the user 1300 from buying product B is =sum of the length of the arc for the personality trait openness and length of the arc for the personality trait extraversion=2πOb×[(6−(−4))/20]+[(2πEb)×(1−(−1)/20]=4π+6π for Ob=3 and Eb=4.

Therefore, affinity of the user 1300 towards product B is more than the affinity of the user 1300 towards the product A. The user 1300 is closer to the product B.

In another exemplary embodiment, affinity of the user towards a product is calculated as follows:

For a particular product, the affinity is estimated as follows: Affinity is expressed as a function of personality scores of users in existing database and incoming new user. Affinity (A)=f(O,C,E,A,N)

(Od, Cd, Ed, Ad, Nd): the mean value of personality scores for each trait, computed for all persons in the existing user database who exhibited affinity towards a product.

(Ou, Cu, Eu, Au, Nu): the personality scores estimated for the new incoming user

(εo, εc, εe, εa, εn): Big-Five Elasticity Coefficients computed by Elasticity Calculator 114 at the point (Od, Cd, Ed, Ad, Nd) on the modelled surface. Big-Five Elasticity Coefficient for openness (εo)=partial derivative of function f with respect to trait O=δf/dO

dA: Change or variation in the affinity value between the incoming user and persons who have exhibited affinity towards the product

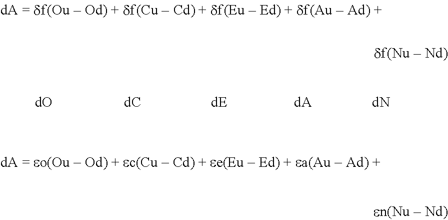

The higher the value of dA, the greater is the affinity of the user of interest towards the product. The advantage of this model is that it helps to attribute more weightage to smaller variations in trait of a person from the general benchmark, if the trait is significant. The product affinity of the user indicates if a product is more suitable to be presented before a user. This tactics checks the system from overlooking an opportunity to suggest a product appealing to lesser number of personality categories while recommending a generally liked product. In other words, a ‘hit’ for a popular product should not be at the opportunity cost of a ‘hit’ for a lesser-favorite one. This enhancement is attributed to understanding of the range of personality profiles a product may cater to, by analysis of variation of product affinity with respect to variation in personality traits.

At step 906, determine aggregate score of the product by using multidimensional hierarchical correlation between the user-attributes and product profiling model. The suitability of the tentative candidates for recommendation identified by the correlation engine 110 is evaluated by integrating information provided by the MIS module 112, product profiles outlined by the elasticity calculator 114 and the feedback engine 120. This method imparts the capability of tuning the recommendation engine 118 to the strategic objectives on the supplier, psychographic portfolio of products and user feedback, over the conventional user-centric approach.

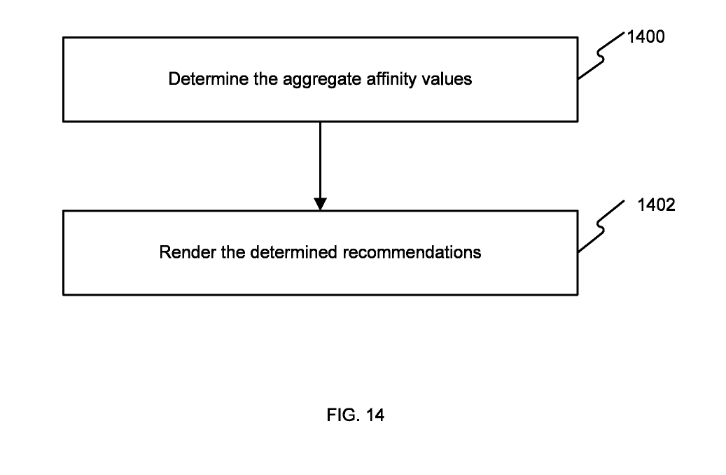

The determination of the aggregate score of the product by using multidimensional hierarchical correlation between the user-attributes and product profiling model is illustrated by way of flowchart in FIG. 14. FIG. 14 illustrates determination of the aggregate affinity towards a product by using multidimensional hierarchical correlation between the user-attributes and product profiling model in accordance with some embodiments of this technology. At step 1400, depending on the user of interest, multidimensional hierarchical collaborative filtering is applied on the corresponding segment of the data cube. For example, customer who are interested in electronics gadget like mp3 player from India demography between the age group of 25-30 and is a male are more likely to buy Sony mp3 player

The aggregate affinity values of the user towards the products tentatively suggested by correlation engine 110, is determined by the affinity prediction engine 116 by aggregation operations. The aggregation operations will predict the effective score generated from MIS, personality profile, feedback, etc.

The scores given by personality-based strategy generator 702—The product suitability may be also determined by correlation of user's personality traits with the product life cycle stages. This module may perform compatibility checks to assess acceptance of a product in terms of its attributes other than psychographic profiling, given user's personality attributes. For each product, depending on the personality-based strategy a supplier wants to implement, based on the configurations in the configuration manager 200, a score may be assigned depending on the personality attributes of the user of interest. The score indicates a relative preference, if any, assigned to a product based on user's attributes. The scores given by personality-based product profiler by comparison of user personality traits with the product profiling model. The scores computed by prioritizing the products for which the out-store movement has to be catalyzed, using the information from the MIS 112. The scores indicative of user's current preference of products, may be assigned based on the analysis of user's browsing pattern and the time spent on each page, as given by feedback engine 120. The scores of recommendation may be calculated during the first level collaborative filtering performed by the correlation engine 110.

This approach may improve the recommendation system by not only taking into account the variation of a user's traits from the general benchmark mined for a product, but also imbibing uniformity or skewness in the differential view of personality trait distribution of its customer base. Besides, by taking into account the inventory management cues given by MIS System and user feedback, the system strategically caters to supplier's objective of catalyzing out-of-store movement of less-favorite goods. The proposed system, thus, empowers the supplier to couple business intelligence with the recommendation system.

At step 1402, render the determined recommendations—The recommendation engine 118 finally may deliver the proposed recommendations to users in real-time. It may comprise of preloaded models which are configurable. The real-time operations may be handled by implementing a distribution framework using dynamic queues. Also, It may be linked to a feedback engine 120 which collects user feedback and helps the models to be self-healing.

### Exemplary Computer System

FIG. 15 is a block diagram of an exemplary affinity analytics computing device or system 1501 that implements embodiments consistent with this technology, such as affinity computing device or system 100. Variations of affinity analytics computing device or system 1501 may be used for implementing any of the devices and/or device components presented in this disclosure, including system 100. Affinity analytics computing device or system 1501 may comprise a central processing unit (CPU or processor) 1502. Processor 1502 may comprise at least one data processor for executing program components for executing user- or system-generated requests. A user may include a person using a device, such as such as those included in this disclosure or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 502 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 1502 may be disposed in communication with one or more input/output (I/O) devices via I/O interface 1503. The I/O interface 1503 may employ communication protocols/methods such as, without limitation, audio, analog, digital, monaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 1503, the affinity analytics computing device or system 1501 may communicate with one or more I/O devices. For example, the input device 504 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 1505 may be a printer, fax machine, video display (e.g., cathode ray tube (CRT), liquid crystal display (LCD), light-emitting diode (LED), plasma, or the like), audio speaker, etc. In some embodiments, a transceiver 1506 may be disposed in connection with the processor 1502. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 518-PMB9800, or the like), providing IEEE 802.11 a/b/g/n, Bluetooth, FM, global positioning system (GPS), 2G/3G HSDPA/HSUPA communications, etc.

In some embodiments, the processor 1502 may be disposed in communication with a communication network 1508 via a network interface 1507. The network interface 1507 may communicate with the communication network 1508. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 1508 may include, without limitation, a direct interconnection, local area network (LAN), wide area network (WAN), wireless network (e.g., using Wireless Application Protocol), the Internet, etc. Using the network interface 1507 and the communication network 1508, the affinity analytics computing device or system 1501 may communicate with devices 1509. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the affinity analytics computing device or system 1501 may itself embody one or more of these devices.

In some embodiments, the processor 1502 may be disposed in communication with one or more memory devices (e.g., RAM 513, ROM 514, etc.) via a storage interface 1512. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 516, user interface application 1517, web browser 1518, mail server 1519, mail client 1520, user/application data 1521 (e.g., any data variables or data records discussed in this disclosure), etc. The operating system 1516 may facilitate resource management and operation of the affinity analytics computing device or system 1501. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 1517 may facilitate display, execution, interaction, manipulation, or operation of program components through textual or graphical facilities. For example, user interfaces may provide computer interaction interface elements on a display system operatively connected to the affinity analytics computing device or system 1501, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the affinity analytics computing device or system 1501 may implement a web browser 1518 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the affinity analytics computing device or system 1501 may implement a mail server 1519 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the affinity analytics computing device or system 1501 may implement a mail client 1520 stored program component. The mail client may be a mail viewing application, such as Apple Mail, Microsoft Entourage, Microsoft Outlook, Mozilla Thunderbird, etc.

In some embodiments, affinity analytics computing device or system 1501 may store user/application data 1521, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more non-transitory computer-readable storage media may be utilized in implementing embodiments consistent with this technology. A non-transitory computer-readable storage medium refers to any type of physical memory on which information or data readable by a processor may be stored. Thus, a non-transitory computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for predicting affinity to at least one product based on personality profile of at least one user, the method comprising:
generating, by an affinity analytics computing device, at least one personality trait score for each of at least one personality trait for each of the at least one user, the at least one personality trait defined by a personality model;
generating, by the affinity analytics computing device, at least one elasticity coefficient for each of the at least one personality trait, the elasticity coefficient indicative of variation in the affinity towards the at least one product with respect to the variation in the at least one personality trait;
arranging, by the affinity analytics computing device, one or more scales based on magnitude of the one or more elasticity coefficients, each of the one or more scales extending between a first scale value and a second scale value;
marking, by the affinity analytics computing device, on each of the one or more scales the personality trait score of the at least one user and corresponding threshold score for users of interest with respect to the at least one product for each of the at least one personality trait to determine difference between the personality trait score and the corresponding threshold score for each of the at least one personality trait;
providing, by the affinity analytics computing device, one or more weights to the corresponding determined differences based on the magnitude of the elasticity coefficients; and
predicting, by the affinity analytics computing device, the affinity based on summing the weighted differences between the personality trait score and the corresponding threshold score for each of the at least one personality trait.

2. The method of claim 1, wherein the affinity is inversely proportional to the sum of the weighted differences between the personality trait score and the corresponding threshold score for each of the at least one personality trait.

3. The method of claim 1, wherein the weights are directly proportional to the magnitude of the elasticity coefficients.

4. The method of claim 1, further comprising providing, by the affinity analytics computing device, a recommendation regarding suitability of the at least one product for the at least one user, the recommendation based on the affinity, demography, and occasion for buying the at least one product.

5. The method of claim 1, wherein the personality model is big five personality model.

6. The method of claim 4, wherein the recommendation is based on correlation of the at least one personality trait of the at least one user with one or more life cycle stages of the at least one product.

7. The method of claim 1, wherein the one or more scales are arranged based on increasing/decreasing order of the magnitude of the one or more elasticity coefficients.

8. The method of claim 1, further comprising providing, by the affinity analytics computing device, a feedback based on correlation between browsing pattern of the at least one user and time spent on looking at the at least one product.

9. An affinity analytics computing device comprising:
one or more hardware processors; and
a memory storing instructions that, when executed by the one or more hardware processors, cause the one or more hardware processors to perform operations comprising:
generating at least one personality trait score for each of at least one personality trait for each of the at least one user, the at least one personality trait defined by a personality model;
generating at least one elasticity coefficient for each of the at least one personality trait, the elasticity coefficient indicative of variation in the affinity towards the at least one product with respect to the variation in the at least one personality trait;
arranging one or more scales based on magnitude of the one or more elasticity coefficients, each of the one or more scales extending between a first scale value and a second scale value;
marking, on each of the one or more scales, the personality trait score of the at least one user and corresponding threshold score for users of interest with respect to the at least one product for each of the at least one personality trait to determine difference between the personality trait score and the corresponding threshold score for each of the at least one personality trait;
providing one or more weights to the corresponding determined differences based on the magnitude of the elasticity coefficients; and
predicting the affinity based on summing the weighted differences between the personality trait score and the corresponding threshold score for each of the at least one personality trait.

10. The device of claim 9, wherein the affinity is inversely proportional to the sum of the weighted differences between the personality trait score and the corresponding threshold score for each of the at least one personality trait.

11. The device of claim 9, wherein the weights are directly proportional to the magnitude of the elasticity coefficients.

12. The device of claim 9, wherein a recommendation regarding suitability of the at least one product for the at least one user is provided, the recommendation based on the affinity.

13. The device of claim 9, wherein the personality model is big five personality model.

14. The device of claim 12, wherein the recommendation is based on correlation of the at least one personality trait of the at least one user with one or more life cycle stages of the at least one product.

15. The device of claim 9, wherein the one or more scales are arranged based on increasing/decreasing order of magnitude of the one or more elasticity coefficients.

16. The device of claim 9, wherein a feedback is provided, the feedback based on correlation between browsing pattern of the at least one user and time spent on looking at the at least one product.

17. A non-transitory computer-readable medium storing instructions for predicting affinity to at least one product based on personality profile of at least one user that, when executed by a processor, cause the processor to perform operations comprising:
generating at least one personality trait score for each of at least one personality trait for each of the at least one user, the at least one personality trait defined by a personality model;
generating at least one elasticity coefficient for each of the at least one personality trait, the elasticity coefficient indicative of variation in the affinity towards the at least one product with respect to the variation in the at least one personality trait;
arranging one or more scales based on magnitude of the one or more elasticity coefficients, each of the one or more scales extending between a first scale value and a second scale value;
marking, on each of the one or more scales, the personality trait score of the at least one user and corresponding threshold score for users of interest with respect to the at least one product for each of the at least one personality trait to determine difference between the personality trait score and the corresponding threshold score for each of the at least one personality trait;
providing one or more weights to the corresponding determined differences based on the magnitude of the elasticity coefficients; and
predicting the affinity based on summing the weighted differences between the personality trait score and the corresponding threshold score for each of the at least one personality trait.

18. The non-transitory computer-readable medium of claim 17, wherein the affinity is inversely proportional to the sum of the weighted differences between the personality trait score and the corresponding threshold score for each of the at least one personality trait.

19. The non-transitory computer-readable medium of claim 17, wherein the weights are directly proportional to the magnitude of the elasticity coefficients.

20. The non-transitory computer-readable medium of claim 17, wherein the medium stores further instructions that, when executed by the one or more hardware processors, cause the one or more hardware processors to perform operations comprising: providing a recommendation regarding suitability of the at least one product for the at least one user, the recommendation based on the affinity.
